(19) United States
(12) Patent Application Publication
(10) Pub. No.: US 2007/0061504 A1
(43) Pub. Date: Mar. 15, 2007

(54) Apparatus and method for managing data of flash memory

(76) Inventor: Woon-Kyun Lee, Suwon-si (KR)

Correspondence Address: Robert E. Bushnell;Suite 300, 1522 K Street, N.W., Washington, DC, 20005, US

(21) Appl. No.: 11/501,730

(22) Filed: Aug. 10, 2006

(30) Foreign Application Priority Data
Aug. 22, 2005 (KR) 10-2005-0076991

(51) Int. Cl. G06F 12/00

(52) U.S. Cl. 711/103

(57) ABSTRACT

In an apparatus and a method for managing data of a flash memory, when update of data stored in the flash memory is requested, a stored data set is compared with a new data set and only bits of the stored data set that are different from corresponding bits of the new data set are changed. Thus, the number of bits to be changed is reduced, and the time taken to manage data of the flash memory decreases.

### CLAIM OF PRIORITY

This application makes reference to, incorporates the same herein, and claims all benefits accruing under 35 U.S.C. §119 from an application for APPARATUS AND METHOD FOR MANAGING DATA ON FLASH MEMORY, filed in the Korean Intellectual Property Office on Aug. 22, 2005 and there duly assigned Serial No. 10-2005-0076991.

### BACKGROUND OF THE INVENTION

1. Technical Field

The present invention relates to an apparatus and method for managing data of a flash memory.

2. Related Art

A flash memory consumes little power and retains stored information, even when the power is turned off. That is, a flash memory is a nonvolatile memory, and thus it can retain stored information in the event of a power loss. In addition, a flash memory allows free input/output of information. Due to these characteristics, flash memories are widely used in digital camcorders, digital cameras, video game devices, Moving Picture Experts Group-1 audio layer-3 (MP3) players, mobile terminals, and so forth.

The operation of writing data to a flash memory takes somewhere from tens of microseconds to tens of milliseconds, and the operation of erasing data in a flash memory takes a very long time, that is, tens of milliseconds to several seconds. Due to hardware characteristics, however, the flash memory first performs an operation that erases an entire block, including an already written memory sector, in order to perform a writing operation in the memory sector. The erasing operation is a main factor deteriorating the input/output performance of the flash memory.

Generally, there are two methods by means of which a mobile device stores data that is updated as the mobile device operates in a flash memory.

According to the first method, a stored data set (K={A+B+C+D}) of a sector F in which new data D′ is to be written is read into a static random access memory (SRAM) field or a synchronous dynamic random access memory (SDRAM) field, data D is updated with the new data D′ (K′={A+B+C+D′}), the sector F in which the data set K is recorded is erased, and the updated data set K′ is re-recorded in the sector F.

According to the second method, assuming that a sector size is larger than the size of a data set and there is always an empty sector F2, new data D′ is added to a stored data set (K={A+B+C+D}) of a sector F1 in which the new data D′ is to be recorded. Thereby, a new data set (K′={A+B+C+D′}) is formed, and stored data D alone is recorded as no longer valid (K″={A+B+C+D+D′}). Because no erasing operation is included in most cases of updating data, overall writing performance is improved. However, since valid data coexists with invalid data in a data set, an additional operation is required to determine if the corresponding data is valid when the data set is used. In addition, since data is added without an erasing operation, the size of the data set K″ continuously increases. When the size of a data set becomes the same as the sector F1, or when data cannot be added any more, garbage collection, an operation in which only valid data is copied from a data set to the empty sector F2 to form a new data set and the sector F1 is emptied by erasure, is required.

According to a conventional storage method of a flash memory, the stored data D should be updated with the new data D′, even if only one bit is different between the stored data D and new data D′. According to the first method, an entire sector is erased and a whole data set is re-recorded. On the other hand, according to the second method, the new data D′ is additionally recorded in its entirety; it is impossible to overwrite only a part of the stored data set K. Thus, data that need not be changed is changed, and a number of erasing operations are required.

As described above, the erasing operation for a flash memory takes a long time. In addition, more current is required to erase and write to a flash memory than is required to simply write to a flash memory. Therefore, the entire system performance can be improved by reducing the number of erasing operations as much as possible, and also by minimizing the number of writing operations.

### SUMMARY OF THE INVENTION

It is an object of the present invention to provide an apparatus and method for managing data of a flash memory wherein the number of times that an operation of erasing data stored in the flash memory is performed is reduced.

It is another object of the present invention to provide an apparatus and method for managing data of a flash memory wherein the number of times that an erasing operation and a writing operation are performed when the flash memory manages data is reduced.

The present invention described below reduces the amount of data to be written and the number of times that a flash memory is erased through software-based data selection and control, and thus improves the input/output performance of a mobile device.

According to an exemplary embodiment of the present invention, an apparatus for managing data of a flash memory comprises: a controller which, when a request to update a data set stored in the flash memory is generated, determines whether bits of the stored data set to be updated are the same as, or different than, respective bits of a new data set, and updates bits of the stored data set which are different.

The controller determines whether or not each different bit of the stored data set is 1, and whether or not each corresponding bit of the new data set is 0, and performs an overwriting operation when a different bit of the stored data set is 1 and a corresponding bit of the new data set is 0.

Also, when the flash memory stores an index value, the stored data has the following format: IDX(K)<---((2ˆN−1)<<K), K=0, 1, 2, 3, . . . Furthermore, the data format maybe represented by the result of shifting a number K of bit values on the right when values of all N bits of a data type of the stored data are 1.

According to another aspect of the present invention, a method for managing data of a flash memory comprises the steps of: detecting the generation of a request to update a data set stored in the flash memory; determining whether bits of the stored data set to be updated in response to the request are the same as, or different than, respective bits of a new data set; and updating bits of the stored data set that are different than the respective bits of the new data set.

In the updating step, an overwriting operation may be performed when a bit of the stored data set is 1 and a corresponding bit of the new data set is 0.

Also, when the flash memory stores an index value, the stored data may have the following format: IDX(K)<---((2ˆN−1) <<K), K =0, 1, 2, 3, . . . .

In general, a value of a flash memory should be updated when a user changes a setting of a mobile device while operating the device. In the case of a cellular phone, the value may represent the volume or the type of a ring tone, the type of background image, etc. When the user changes such a setting, data such as an index value indicating the setting is changed. Therefore, when the data is updated, for example, among three types of ring tone data, the volume of the ring tone is changed from 1 to 2, or the type of the ring tone is changed from 1 to 5. In other words, only a part of data in a data set is changed. According to the present invention, when a part of data in a data set stored in a flash memory is changed, the data storage performance of the flash memory is improved with a properly defined index value according to an improved flash memory storage algorithm.

When data is stored in the flash memory, the apparatus for managing data of the flash memory determines whether or not the new data D′ can be written without erasing the data D already stored in the flash memory, and stores the data according to the result.

In addition, the apparatus for managing data of the flash memory sets up a data value in index form considering the characteristics of the flash memory, and thus the apparatus writes the new data D′ without erasing the data D already stored in the flash memory.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram of an apparatus for managing data of a flash memory according to an exemplary embodiment of the present invention; and

FIG. 2 is a flowchart of a method for managing data of a flash memory according to the present invention.

### DETAILED DESCRIPTION OF EXEMPLARY EMBODIMENTS

Hereinafter, exemplary embodiments of the present invention will be described in detail with reference to the accompanying drawings. Matters related to the present invention and well-known in the art will not be described in detail when it is deemed that such description would detract from the clarity and conciseness of the disclosure.

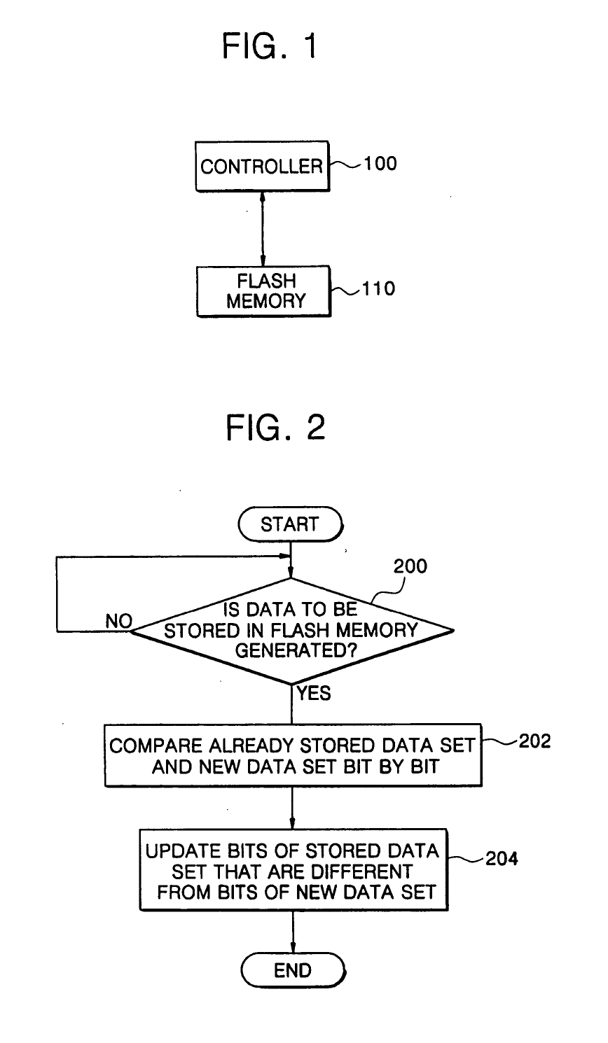

FIG. 1 is a block diagram of an apparatus for managing data of a flash memory according to an exemplary embodiment of the present invention.

As shown in FIG. 1, the apparatus for managing data of a flash memory comprises a controller 100 and a flash memory 110. The data managing apparatus may further comprise a random access memory (RAM) (a static RAM (SRAM) or a synchronous dynamic RAM (SDRAM) is generally used), which is not shown in the drawings.

The flash memory 110 stores data. The controller 100 manages the data of the flash memory 110. When data to be stored in the flash memory 110 is generated, the controller 100 determines whether or not the new generated data can be written without erasing data already stored in the flash memory 110, and the controller 100 stores the data according to the result. In addition, the controller 100 sets up data values in index form considering the characteristics of the flash memory 110.

Operations of the controller 100 will be described below in detail with examples.

The operation of determining whether or not the new generated data can be written without erasing the stored data will be described first.

In the process of updating data of the flash memory 110 with new data, the controller 100 compares the new data with the stored data to determine whether or not the stored data can be overwritten with the new data without erasing the stored data. Data stored in the flash memory 110 can be changed from a bit value of 1 to a bit value of 0 by means of a writing operation. Therefore, it is determined whether or not the new data value can be formed by only changing one of the bit values of the stored data into 0.

For example, when the data stored in the flash memory 110 is 0xFA (0b11111010 in bit value) and the new data to be updated is 0xB0 (0b11111010 in bit value), in order to update the stored data, only the values of the second bit, fourth bit and seventh bit need be changed from 1 into 0. In other words, by overwriting, the data already stored in the flash memory 110 can be updated with the new data.

Meanwhile, when the data stored in the flash memory 110 is 0xFA (0b1111010 in bit value) and the new data is 0xB1 (0b 10110001 in bit value), the value of the first bit must be changed from 0 into 1. In this case, the writing operation cannot be performed without an erasing operation. In other words, overwriting is impossible.

When overwriting is impossible, conventional storage methods of the flash memory 110 are used to store the updated data.

The operation of the controller 100 described above is represented in conditional expressions below. Here, it is assumed that the stored data is D and the new data is D′.
D==(D&D′) [1]

When the result of a bit-and operation of D and D′ is the same as D, overwriting is possible.
D!=(D&D′) [2]

When the result of a bit-and operation of D and D′ is not the same as D, overwriting is impossible.

When conditional expression [1] is satisfied, and when the new data D′ is simply overwritten at the location of the stored data D, the stored data D is normally updated due to the characteristics of the flash memory 110.

The operation of the controller 100 which sets up data values in index form considering the characteristics of the flash memory 110 will now be described.

In general, an index value 1 used in a programming process increases from 0 in increments of 1. For example, a first ring tone of a cellular phone has an index value of 0, a second ring tone has an index value of 1, a third ring tone has an index value of 2, and so forth. The writing operation for the flash memory 110 replaces a bit value of I with a bit value of 0, the bit values being stored in a storage cell. Therefore, the data of the flash memory 110 can be changed merely by a writing operation without an erasing operation. That is, a bit value of 1 can always be changed into 0.

For example, an index value 1 is set to 0 for the first ring tone, 1 for the second ring tone, 2 for the third ring tone, and so forth, and is stored in the flash memory 110 in eight-bit format. In this case, the stored values are 0b00000000, 0b00000001, 0b00000010, and so forth. When the flash memory writing operation is performed to change the second ring tone to the third ring tone, the first bit value of 0b00000001, i.e., 1, can be changed into 0, but the second bit value of 0 cannot be changed into 1. Meanwhile, when the index value is set to 255 for the first ring tone, 254 for the second ring tone, and 252 for the third ring tone, the stored values are 0b11111111, 0b11111110 and 0b11111100. Then, when the second ring tone is changed into the third ring tone, 0b11111110 is changed into 0b11111100, and thus only the second bit value of 1 has to be changed into 0. Since this can be achieved merely by a flash memory writing operation, the stored data can be overwritten with the new data.

In other words, it is possible to increase the number of times that overwriting is performed by properly setting up the index values of data. The index values of data can be set up as follows.

In a value where the values of all N bits of the data type of stored data are 1, a number K of bit values on the right are shifted. Thereby, the index value stored in the flash memory 110 is set up as follows:
IDX(K)<---((2ˆN−1)<<K)

Here, K =0, 1, 2, 3, . . . For example, index values used for a variable of eight-bit data can be set up as follows:
IDX(0)<---((2ˆ8−1)<<0)=0xFF=0b11111111 (1)
IDX(1)<---((2ˆ8−1)<<1)=0xFE=0b11111110 (2)
IDX(2)<---((2ˆ8−1)<<2)=0xFC=0b11111100 (3)
IDX(3)<---((2ˆ8−1)<<3)=0xF8=0b11111000 (4)

Examples (1), (2), (3) and (4) above are described as follows: Example (1) represents data in which 0 bit values are shifted, and thus is eight-bit data in which all bit values are 1, i.e., 11111111. This can be expressed as FF in hexadecimal notation. Example (2) represents data in which 1 bit value is shifted, and thus is eight-bit data in which the first bit value is 0 and all other bit values are 1, i.e., 11111110. This can be expressed as FE in hexadecimal notation. Example (3) represents data in which 2 bit values are shifted, and thus is eight-bit data in which the first and second bit values are 0 and all other bit values are 1, i.e., 11111100. This can be expressed as FC in hexadecimal notation. Example (4) represents data in which 3 bit values are shifted, and thus is eight-bit data in which the first, second and third bit values are 0 and all other bit values are 1, i.e., 11111000. This can be expressed as F8 in hexadecimal notation.

When the index values mentioned above are used for the variable stored in the flash memory 110, and when the index value increases, only the operation that changes 1 to 0, i.e., the writing operation, is required. Therefore, when a request to update data stored in the flash memory 110 is generated and the index value increases, the apparatus can update a value without erasing data stored in the flash memory 110.

A method for managing data of the flash memory according to the present invention will be described below with reference to the accompanying drawings.

FIG. 2 is a flowchart of the method for managing data of the flash memory according to the present invention.

When generation of data to be stored in the flash memory 110 is detected (step 200), the apparatus of the present invention determines whether or not bits of a stored data set to be updated are the same as respective new bits (step 202). Subsequently, according to the result of the latter determination, the apparatus updates bits of the stored data set which are different from corresponding bits of a new data set (step 204).

Meanwhile, when data is stored in the flash memory 110, the apparatus of the present invention can store the data by properly setting up index values as described above.

As described above, the present invention reduces the number of times that a writing operation is performed, and allows overwriting when data is stored in the flash memory 110.

An operation that writes data in flash memory 110 takes between tens of microseconds and tens of milliseconds, and an operation that erases data in flash memory 110 takes a very long time, that is, tens of milliseconds to several seconds. In addition, operations that write and erase data of flash memory 110 require more current than a writing operation alone. Therefore, overall system performance can be improved by reducing the number of times that erasing and writing operations are performed. The present invention provides a method of setting up data to be recorded in flash memory 110, considering the characteristics of the flash memory 110, determining whether or not data recorded in the flash memory 110 can be overwritten, and thus reducing the number of times that an operation of erasing the flash memory 110 is performed, as well as the amount of data to be written.

As described above, according to the present invention, it is possible to reduce the number of times that the erasing and writing operations are performed when data is stored in the flash memory 110, so that performance, such as data storage speed and the like, can be improved.

While the present invention has been described with reference to exemplary embodiments thereof, it will be understood by those skilled in the art that various changes in form and detail may be made therein without departing from the scope of the present invention as defined by the following claims.

What is claimed is:

1. An apparatus for managing data of a flash memory, comprising:
a controller which, when a request to update a data set stored in the flash memory is generated, determines whether bits of the stored data set to be updated are the same as or different than respective bits of a new data set, wherein the controller updates bits of the stored data set which are different.

2. The apparatus of claim 1, wherein the controller determines whether each different bit of the stored data set is 1 and whether each corresponding bit of the new data set is 0, and the controller performs an overwriting operation when a different bit of the stored data set is 1 and a corresponding bit of the new data set is 0.

3. The apparatus of claim 1, wherein, when the flash memory stores an index value, the stored data has the following format:
IDX(K)<---((2ˆN−1)<<K),K=0, 1, 2, 3, . . . .

4. The data managing apparatus of claim 3, wherein the data format is represented by a result of shifting a number K of bit values on the right when values of all N bits of a data type of the stored data are 1.

5. A method of managing data of a flash memory, comprising the steps of:
detecting generation of a request to update a data set stored in the flash memory;
determining whether bits of the stored data set to be updated in response to the request are the same as or different than respective bits of a new data set; and
updating bits of the stored data set that are different than respective bits of the new data set.

6. The method of claim 5, wherein the updating step comprises performing an overwriting operation when a bit of the stored data set is 1 and a corresponding bit of the new data set is 0.

7. The method of claim 5, wherein, when the flash memory stores an index value, the stored data has the following format:
IDX(K)<---((2ˆN−1)<<K),K=0, 1, 2, 3, . . . .

8. The method of claim 7, wherein the data format is represented by a result of shifting a number K of bit values on the right when values of all N bits of a data type of the stored data are 1.
